(19) United States
(12) Patent Application Publication
(10) Pub. No.: US 2021/0250419 A1
(43) Pub. Date: Aug. 12, 2021

(54) CONTEXTUAL NOTIFICATION INTERFACE

(71) Applicant: Statum Systems Inc., Wellesley, MA (US)

(72) Inventors: Stephen Michael Okajima, Boston, MA (US); Arman Serebrakian, Boston, MA (US); Ara Nazarian, Wellesley, MA (US)

(21) Appl. No.: 16/785,943

(22) Filed: Feb. 10, 2020

(51) Int. Cl. H04L 29/08; H04L 29/06; H04L 12/24

(52) U.S. Cl. CPC H04L 67/306; H04L 67/22; H04L 67/26; H04L 41/22; H04L 67/42

(57) ABSTRACT

A system is configured to perform operations that include: accessing a user profile associated with a user account; identifying a set of user roles based on the one or more user attributes and a contextual criteria; causing display of a presentation of the set of user roles within a graphical user interface; receiving a selection of a user role from among the presentation of the set of user roles from the client device; and assigning the notification criteria associated with the user role to the user account for the duration indicated by the selection.

### TECHNICAL FIELD

The present invention relates to graphical user interfaces, and more specifically, relates to systems and methods to facilitate notification management within graphical user interfaces.

### BACKGROUND

A push notification (also known as a server push notification) is the delivery of information to a computing device from an application server where the request for the transaction is initiated by the server rather than by an explicit request from the client (i.e., the computing device). While push notifications have become instrumental to communicating with a user of an application, the potential to over-burden the user with excessive notifications must be taken into consideration. As a result, issues pertaining to what, when, and how frequently to push a notification to a client is a common issue related to the field of messaging and push notifications in general. Such issues may also be compounded when considered in the context of the specific compliance standards of a given industry.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram illustrating components of a contextual notification system, according to some example embodiments.

FIG. 3 is a diagram illustrating components of an auxiliary device that may be communicatively coupled with a client device, according to some example embodiments.

FIG. 4 is a diagram depicted an embodiment of the auxiliary device, according to some example embodiments.

FIG. 5 is a flowchart illustrating a method for assigning a set of notification criteria to a user account, according to some example embodiments.

FIG. 6 is a flowchart illustrating a method for presenting a contextual search result, according to some example embodiments.

FIG. 7 is a flowchart illustrating a method for presenting a contextual search result, according to some example embodiments.

FIG. 8 is an interface flow-diagram depicted interfaces generated and displayed by a contextual notification system, according to certain example embodiments.

FIG. 9 is an interface flow-diagram depicted interfaces generated and displayed by a contextual notification system, according to certain example embodiments.

FIG. 10 is an interface flow-diagram depicted interfaces generated and displayed by a contextual notification system, according to certain example embodiments.

FIG. 11 is an interface flow-diagram depicted interfaces generated and displayed by a contextual notification system, according to certain example embodiments.

FIG. 12 is a diagrammatic representation of a machine in the example form of a computer system within which a set of instructions may be executed for causing the machine to perform any one or more of the methodologies discussed herein.

### DETAILED DESCRIPTION

Reference will now be made in detail to specific example embodiments for carrying out the inventive subject matter. Embodiments may be practiced without some or all of these details. It will be understood that the forgoing disclosure is not intended to limit the scope of the claims to the described embodiments. On the contrary, it is intended to cover alternatives, modifications, and equivalents as may be included within the scope of the disclosure as defined by the appended claims. In addition, well known features may not have been described in detail to avoid unnecessarily obscuring the subject matter.

As discussed above, while push notifications are instrumental in facilitating communication with the users of applications, the potential to over-burden the users with excessive notifications must be taken into consideration. Issues pertaining to “what, when, and how” to push a notification to a client device is therefore a common issue related to the field of messaging and push notifications. These issues may also be compounded when considered in the context of the specific compliance standards of a given industry.

For example, the Health Insurance Portability and Accountability Act (HIPAA), exists to define and provide communication and privacy rules for various fields and industries. Such compliance standards seek to allow for the modernization of the flow of information, while addressing the potential of fraud, theft, and privacy. HIPAA sets out strict requirements for the control and transmission of electronic medical data over networks, wherein the transfer of such data must be encrypted if transferred over an open network, or alternatively, much be accessed and transferred on a closed and secured system or network if the data is to remain un-encrypted. HIPAA therefore benefits patients and doctors alike by providing requirements to ensure the privacy and security of medical information. Due to the rules defined by compliance standards like HIPAA, existing messaging and notification platforms fail to provide a legal and legitimate means of distributing and presenting messages to users working in the healthcare sector.

Accordingly, systems and methods to facilitate messaging and the management of notifications under the requirements defined by HIPAA are described herein. Disclosed embodiments may comprise a server-system, a client device in communication with the server-system, and an auxiliary device coupled to the client device, wherein the auxiliary device includes one or more antennas to receive data via one or more specific radio bands that the client device is incapable of receiving due to limitations of the client device itself (i.e., a lack of appropriately tuned antennas), via certain protocol that correspond with the specific radio bands. As used herein, “coupled to” generally refers to a connection between components, which can be an indirect communicative connection or direct communicative connection (e.g., without intervening components), whether wired or wireless, including but not limited to connections such as electrical, optical, magnetic, and near-field communication (NFC).

According to certain embodiments, the system is configured to perform operations that include: accessing a user profile associated with a user account, wherein the user profile comprises user profile data that includes one or more user attributes which may be based on implicit or explicit user activities or inputs; identifying a set of user roles based on the one or more user attributes and a contextual criteria, wherein each role among the set of user roles is associated with one or more notification criteria which may define instances in which a client device is to be pushed a notification; causing display of a presentation of the set of user roles within a graphical user interface (GUI) at a client device; receiving a selection of a user role from among the presentation of the set of user roles from the client device, the selection of the user role indicating a duration that may be based on a temporal period (i.e., 9:00 am to 5:00 pm), an identification of a work shift within a schedule, an event based period that includes an identification of a termination event, or a location based period that comprises an identification of a termination location; and assigning the notification criteria associated with the user role to the user account for the duration indicated by the selection.

As an illustrative example, a user of the system may login to an application associated with the system at a client device. Responsive to receiving the login, the system accesses user profile data associated with the user, wherein the user profile data includes user attributes that include an organizational title (Doctor of Medicine (MD), Registered Nurse (RN), Nurse Practitioner (NP), etc.), a specialty, a sub-specialty, a department, security clearance level, a list of associated patients, a schedule of shift-hours (i.e., when the user is scheduled to be working, or “on-call”), as well as one or more user-defined fields (i.e., automated response message, quote-of-the-day, “about me” section in a user profile). The system then identifies a set of roles to present to the user based on the user attributes and a contextual criteria, wherein the contextual criteria includes a date, a time of day, or a predefined event or condition. The system may then present the set of roles to the user within a GUI at the user's device, such that the user may provide an input selecting a role from the set of roles. For example, the presentation of the set of roles may include a text field for a user to provide a text based input or may comprise a radio selection that comprises a display of each role from among the set of roles. Based on the selection received from the user, the system assigns a set of notification criteria associated with the selected role to a user account associated with the user, wherein the notification criteria define when and how the user is to be notified of certain trigger events. Accordingly, notifications may be presented to the user based on their corresponding notification criteria.

Association of at least a portion of the set of notification criteria may occur at one or both of a database associated with a server of the system, as well as at a client device associated with a user. In doing so, filtering and configuration of notifications may occur at the client device itself, based on notification data received from server side. In further embodiments, the server may itself configure notifications based on the set of notification criteria associated with the recipients of the notifications.

Notification attributes of a notification may include: graphical properties of the notifications; alert properties of an alert associated with the notification, including whether or not an alert is presented or not; message and media content associated with the notification; and a distribution list associated with the notification. Notifications may be presented at a client device based on the corresponding notification attributes, wherein the notification attributes may be defined based on explicit user input or based on properties of message and media content associated with the notification. For example, a notification may include “high priority” content, which may correspond with a predefined set of notification attributes.

In some embodiments, the system may perform operations that further include: receiving a request that includes an identification of the user role from a client device; identifying the user profile associated with the user role in response to the request that includes the identification of the user role; and causing display of a user identifier associated with the user profile at the client device in response to the receiving the request that includes the identification of the user role. As an illustrative example, the system may present a messaging interface at one or more client devices in communication with the system (i.e., client devices that execute an application of the system). The messaging interface may include one or more fields to receive text-based inputs, for example to define a recipient of a message, or to add message content to the message, wherein the message content may include media (i.e., files, images), as well as a string of text. According to certain embodiments, a user may direct a message to another user based on an input that includes a property associated with the user, such as one or more of: a user identifier; a user role associated with the user during a period of time in which the user role has been associated with the user; or by referencing a subject or data object associated with the user within a database of the system (i.e., a patient identifier, a shift, a location, a room number, etc.).

For example, in some embodiments, such as the context of a clinical messaging scenario, the system may maintain a repository (i.e., database) that maintains and updates records of patients and doctors. The system may therefore maintain records comprising patient identifiers, wherein the patient identifiers may be associated with a set of patient attributes that include: demographics information, such as age, sex, gender, height, and weight; a listing of medical records associated with the patient (i.e., from Electronic Health Record data); temporal data indicating a time and date of admittance to a hospital or clinical environment; location data; and an identification of attending doctors, physicians, and staff that have worked with the patient (i.e., based on doctor/user identifier). Similarly, the system may also maintain records comprising doctor identifiers (i.e., user identifiers), wherein the doctor identifiers may be associated with a set of doctor/user attributes that include: area of specialty; work schedule; a listing of patient identifiers which the doctor/user is working with; as well as location data indicating hospitals and clinics in which the doctor has scheduled hours. Thus, by referencing any one of the records above, a plurality of associated records may be returned. For example, reference to a patient identifier may return a result comprising identifiers of doctors and staff associated with the patient may be identified. Similarly, reference to a user identifier (i.e., a doctor, nurse, or other staff), may return a listing of patients which the user is involved.

Accordingly, responsive to receiving the input that identifies a user (i.e., a doctor or staff member) based on one or more of the user attributes of the user, the contextual notification interface accesses the repository to identify a corresponding user identifier associated with the user attribute, and causes display of the user identifier of the user profile of the user at the client device. As an illustrative example, the contextual notification interface may display a text input field within a messaging interface, wherein a first user may provide an input to identify a recipient of a message. In a traditional clinical messaging scenario, an intended recipient of the message may be dependent upon who is on call or on schedule at a particular time, or who is assigned to a patient at a particular time. As a result, the sender of the message (the first user) may be required to search a schedule in order to determine who to direct the message to. This step is often time consuming and tedious and may also be prone to error and mistakes due to schedules occasionally not being updated regularly or being unavailable at a given time.

The disclosed system therefore seeks to resolve this technical issue by providing an interface that enables the first user to identify a second user (i.e., a recipient of a message), by simply providing an input that identifies a property of the user, such as being “on-call” at a particular time. Accordingly, responsive to receiving the input that identifies a property associated with the user, the contextual notification interface identifies the second user (i.e., the intended recipient of the message), and causes display of the user identifier associated with the intended recipient at the client device of the first user.

In some example embodiments, notifications distributed by the system may be generated by a user of the system at a client device. For example, the user of the system may be a user with administrative permissions. In such embodiments, the user may provide inputs to generate the notification. Inputs to define notification content to be presented in the notification. Notification content may for example include: an identification of a patient identifier; an identification of a condition, such as a medical condition; an identification of a location; an indication of an urgency; as well as an identification of one or more recipients. In such embodiments, the system may generate a notification to be distributed to one or more recipients by identifying the one or more recipients based on the notification content. As an illustrative example, the notification content may include an identification of a medical condition. Responsive to receiving the identification of the medical condition, the system may access a repository to identify one or more users (i.e., doctors, nurses, staff) who may be associated with the medical condition based on past experience with the medical condition (e.g., a user history), association with current a patient who has the medical condition, as well as a specialization in the medical condition.

The system may then distribute the notification to the one or more recipients by distributing the notification to an auxiliary device associated with the one or more recipients which is communicatively coupled to a client device associated with the one or more recipients, wherein the notification may then be presented at one or more client devices associated with the one or more recipients based on notification criteria which are associated with each of the one or more recipients. For example, some recipients may be presented with an urgent alert that includes a display of at least a portion of the message content, while some recipients may not be presented with an alert but may simply receive the message content which may then be used to populate a messaging interface presented at the client device.

In some embodiments, the notification content may vary based on a communication pathway used by the system to distribute the notification to the one or more recipients. For example, according to certain example embodiments discussed herein, the system may include an auxiliary device which may be communicatively coupled to a client device, wherein the auxiliary device is configured to receive data via one or more predefined radio frequencies. The system may therefore format notification content according to the communication pathway to be used. Notifications to be distributed via Wi-Fi or 802.11 may be formatted one way, whereas notifications to be distributed via a pager network may be formatted another way.

In some embodiments, the contextual notification interface may additionally provide one or more GUI to generate and cause display of a set of user context based search results. According to such embodiments, the contextual notification system may cause display of a search interface at a client device of a user, wherein the user may provide a search request into the search interface, wherein the search request includes search criteria. Responsive to receiving the search request, the contextual notification system accesses metadata associated with the search request, wherein the metadata includes contextual data indicating one or more of: a time of day; a location of the client device; and user profile data associated with the user of the client device.

Based on the search request, the contextual notification system accesses a repository that comprises a collection of data records and generates a set of search results based on the search criteria and at least a portion of the metadata associated with the search request. The contextual notification interface may then cause display of a presentation of the search results at the client device, wherein the presentation of the search results may also be based on the metadata. For example, a sorting of the search results among the presentation of the set of search results may be determined based on the metadata.

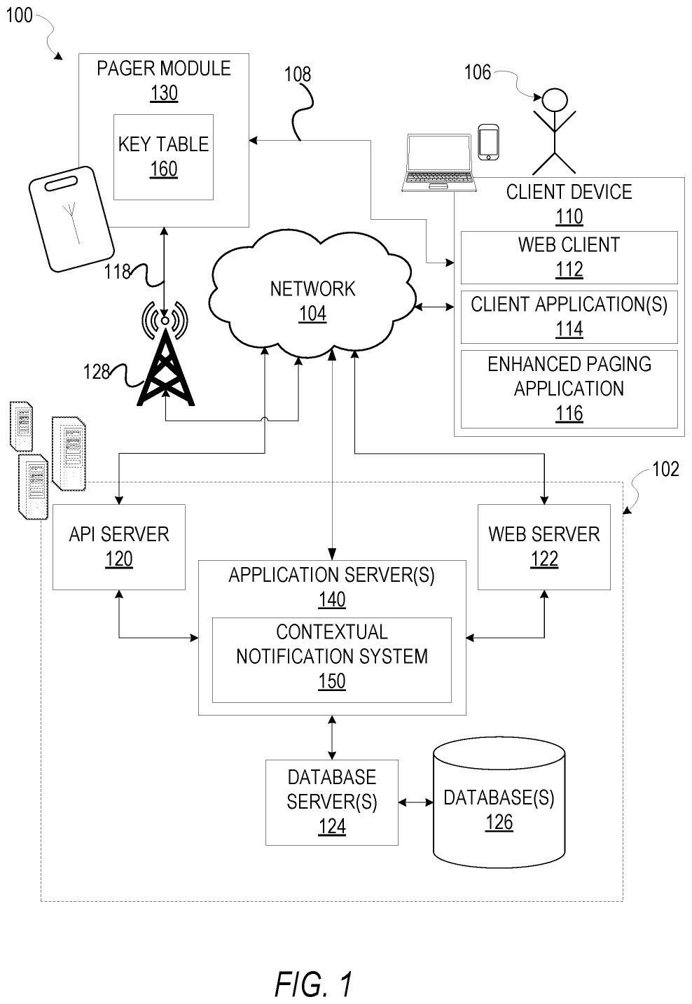

FIG. 1 is an example embodiment of a high-level client-server-based network architecture 100. A networked system 102 provides server-side functionality via a network 104 to one or more client devices 110, and to a pager network 128 which distributes data to an auxiliary device 130 via the communication channel 118. FIG. 1 illustrates, for example, a web client 112 (e.g., a browser, such as the Internet Explorer® browser developed by Microsoft® Corporation of Redmond, Wash. State), client application(s) 114, and an enhanced paging application 116 executing on the client device 110.

The client device 110 may comprise, but is not limited to, a wearable device, mobile phone, desktop computer, laptop, portable digital assistant (PDA), smart phone, tablet, ultra-book, netbook, laptop, multi-processor system, microprocessor-based or programmable consumer electronics, game console, set-top box, or any other communication device that a user may utilize to access the networked system 102. In some embodiments, the client device 110 comprises a display module (not shown) to display information (e.g., in the form of user interfaces). In further embodiments, the client device 110 comprises one or more of touch screens, accelerometers, gyroscopes, cameras, microphones, global positioning system (GPS) devices, and so forth. The client device 110 may be a device of a user configured to facilitate communication within the networked system 102. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, a Wireless Mesh Network (WMN), or a combination of two or more such networks.

The client device 110 may include one or more client applications 114 (also referred to as “apps”) such as, but not limited to, a web browser, messaging application, electronic mail (email) application, a navigation application, and the like. In some embodiments, the client application(s) 114 is configured to locally provide the user interface and at least some of the functionalities with the client application(s) 114 configured to communicate with the networked system 102, on an as needed basis, for data or processing capabilities not locally available (e.g., access to a database of items available for sale, to authenticate a user, to verify a method of payment). Conversely, the client device 110 may use its web browser to access data hosted on the networked system 102 to generate and provide various user interfaces.

An auxiliary device 130 may be communicatively coupled to the client device 110 via one or more communication pathways 108. For example, the communication pathways 108 may be an indirect communicative connection or direct communicative connection (e.g., without intervening components), whether wired or wireless, including but not limited to connections such as electrical, optical, magnetic, and near-field communication (NFC). For example, in some embodiments, the auxiliary device 130 may be communicatively coupled to the client device via Bluetooth or Bluetooth Low Energy (BLE). In some embodiments, the auxiliary device 130 may include one or more antenna, wherein the antenna are tuned to receive data via one or more specified communication bands, including but not limited to Very High Frequency (VHF), and in some instances Ultra High Frequency (UHF) bands. VHF, and in some instances, UHF, bands of the radio spectrum offer higher signal penetration and range than higher frequency bands typically used in Wi-Fi and cellular networks. Accordingly, the auxiliary device 130 may be configured to receive data via a 4-bit Binary-coded decimal (BCD) values, as well as 7-bit American Standard Code for Information Interchange (ASCII). According to such embodiments, the network 104 may additionally include a pager network, wherein the pager network comprises a plurality of transmitter antennas configured to distribute data to the auxiliary device 130 (i.e., an auxiliary device 130) via a communication pathway 118 that comprises a predefined set of frequencies, including but not limited to VHF and UHF.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input, alphanumeric input, text-to-speech, or speech-to-text) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application server(s) 140 may host an contextual notification system 150, for providing encrypted communications between an application server 140 (e.g., a server system), and the client device 110. For example, the contextual notification system 150 may generate encryption keys in response to requests from the client device 110 and transmit the encryption keys, or portions of the encryption keys, to an auxiliary device (e.g., the auxiliary device 130) coupled to the client device 110. The client device 110 may then access the auxiliary device 130 to retrieve the appropriate encryption keys received from the contextual notification system 150. For example, in some embodiments, the auxiliary device 130 may include one or more memory components to host a key table 160, wherein the key table 160 is configured to maintain a list of encryption keys, which may be sorted or labeled based on a request instance, or an identifier of a data object (e.g., a message, media content, etc.). In such embodiments, the client device 110 may access the key table 160 of the auxiliary device 130 to retrieve an encryption key that corresponds with an encrypted data object accessed by the client device 110.

While the client-server-based network architecture 100 shown in FIG. 1 employs a client-server architecture, the present inventive subject matter is of course not limited to such an architecture, and could equally well find application in a distributed, or peer-to-peer, architecture system, for example. The contextual notification system 150 could also be implemented as standalone software programs, which do not necessarily have networking capabilities.

The web client 112 may access the various publication and payment systems 142 and 144 via the web interface supported by the web server 122. Similarly, the enhanced paging application 116 accesses the various services and functions provided by the contextual notification system 150 via the programmatic interface provided by the API server 120. The enhanced paging application 116 may, for example, generate and cause display of notifications in response to receiving message data from an associated auxiliary device 130.

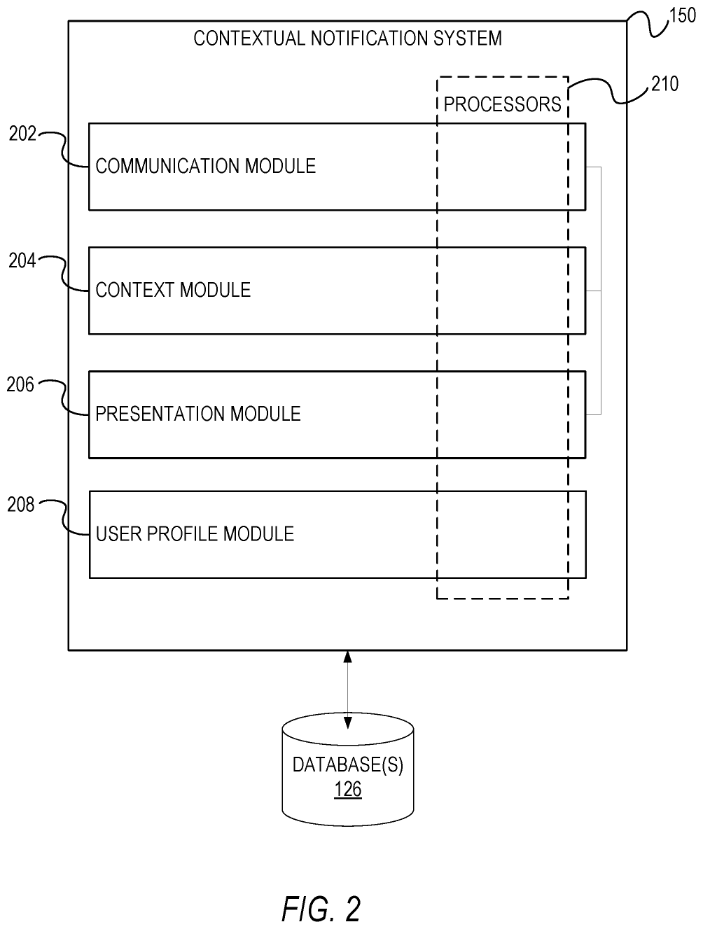

FIG. 2 is a block diagram illustrating components of the contextual notification system 150 that configure the contextual notification system 150 to perform operations that in some embodiments include: accessing a user profile associated with a user account, wherein the user profile comprises user profile data that includes one or more user attributes which may be based on implicit or explicit user activities or inputs; identifying a set of user roles based on the one or more user attributes and a contextual criteria, wherein each role among the set of user roles is associated with one or more notification criteria which may define instances in which a client device is to be pushed a notification; causing display of a presentation of the set of user roles within a GUI at a client device 110; receiving a selection of a user role from among the presentation of the set of user roles from the client device 110, the selection of the user role indicating a duration that may be based on a temporal 5 period (i.e., 9:00 am to :00 pm), an identification of a work shift within a schedule, an event based period that includes an identification of a termination event, or a location based period that comprises an identification of a termination location; and assigning the notification criteria associated with the user role to the user account for the duration indicated by the selection, according to certain example embodiments. The contextual notification system 150 is shown as including a communication module 202, a context module 204, a presentation module 206, and a user profile module 208, all configured to communicate with each other (e.g., via a bus, shared memory, or a switch). Any one or more of these modules may be implemented using one or more processors 210 (e.g., by configuring such one or more processors 210 to perform functions described for that module) and hence may include one or more of the processors 210. In some embodiments, the modules of the contextual notification system 150 may be in coupled with the databases 126.

Any one or more of the modules described may be implemented using hardware alone (e.g., one or more of the processors 210 of a machine) or a combination of hardware and software. For example, any module described of the contextual notification system 150 may physically include an arrangement of one or more of the processors 210 (e.g., a subset of or among the one or more processors of the machine) configured to perform the operations described herein for that module. As another example, any module of the contextual notification system 150 may include software, hardware, or both, that configure an arrangement of one or more processors 210 (e.g., among the one or more processors of the machine) to perform the operations described herein for that module. Accordingly, different modules of the contextual notification system 150 may include and configure different arrangements of such processors 210 or a single arrangement of such processors 210 at different points in time. Moreover, any two or more modules of the contextual notification system 150 may be combined into a single module, and the functions described herein for a single module may be subdivided among multiple modules. Furthermore, according to various example embodiments, modules described herein as being implemented within a single machine, database, or device may be distributed across multiple machines, databases, or devices.

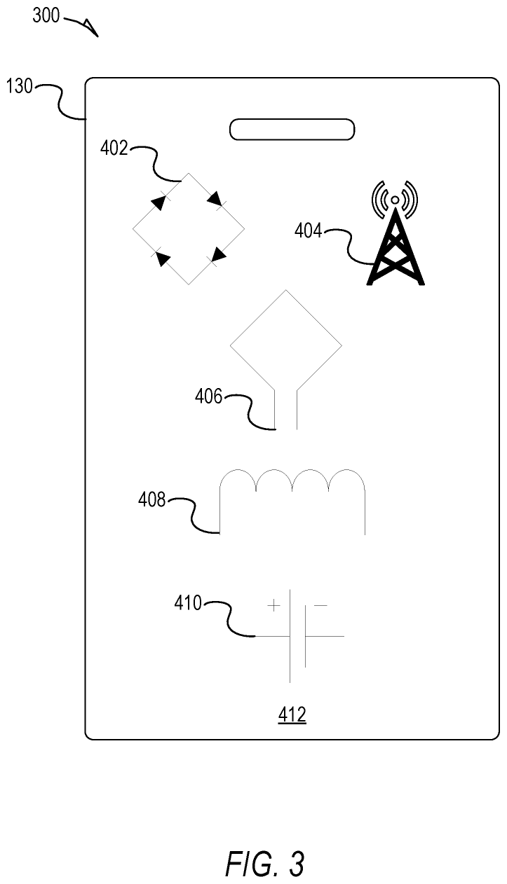

FIG. 3 is a diagram 300 illustrating various functional components of an auxiliary device 130 that may be communicatively coupled with the client device 110. As seen in the diagram 300, the auxiliary device 130 may comprise some or all of a demodulator 302, a transmitter 304, antenna(s) 306, an inductive charging coil 308, and a battery 310, all enclosed within an enclosure 312.

In some example embodiments, the demodulator 302 includes a Frequency Shift Keying (FSK) Demodulator, configured to transmit digital information (e.g., message data) through discrete frequency changes of a carrier signal.

In some example embodiments, the transmitter 304 includes a short-wave radio frequency transmitter (e.g., Bluetooth), configured to forward message data between the auxiliary device 130 and a paired client device 110.

In some example embodiments the antennas 306 include a pair of orthogonal antennas, that may include a loop antenna consisting of a loop of wire, and fully enclosed by the enclosure 312. In some example embodiments, the antennas 306 are integrated into a portion of the enclosure 312. For example, the enclosure 312 may comprise multiple components that come together to form the enclosure 312. In some embodiments, the antennas 306 may be molded or formed into one or more of the components of the enclosure 312.

In some example embodiments, the antennas 306 may be formed into a frame that encompasses a perimeter of a surface of the enclosure 312.

In some example embodiments, the charging coil 308 includes one or more exposed charging leads to enable a use to plug the auxiliary device 130 into an outlet (e.g., USB).

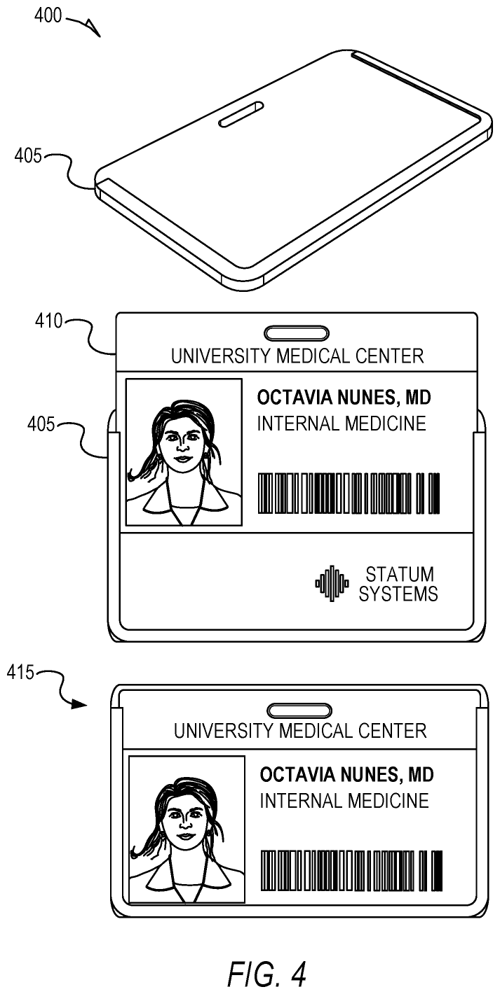

In some example embodiments, the enclosure 312 is the form of a proximity card, such as an identification card, or contactless smart card, or a receptacle to receive and hold an identification card or contactless smart card. In certain embodiments the enclosure 312 may be configured to include a receptacle to receive and hold a card, as depicted in FIG. 4.

FIG. 4 is a diagram 400 depicting an embodiment of the enclosure 312 of the auxiliary device 130. As seen in the diagram 400, the enclosure 312 of the auxiliary device 130 may comprise a sleeve to receive and hold a card.

For example, the enclosure 315 may include the badge holder 405, wherein the badge holder 405 comprises a sleeve along a perimeter of the badge holder 405. As seen in the diagram 400, an identification card 410 may be inserted into the sleeve of the badge holder 405 such that the identification card 405 may be received and held in place by the badge holder 405 as seen in the depiction 415.

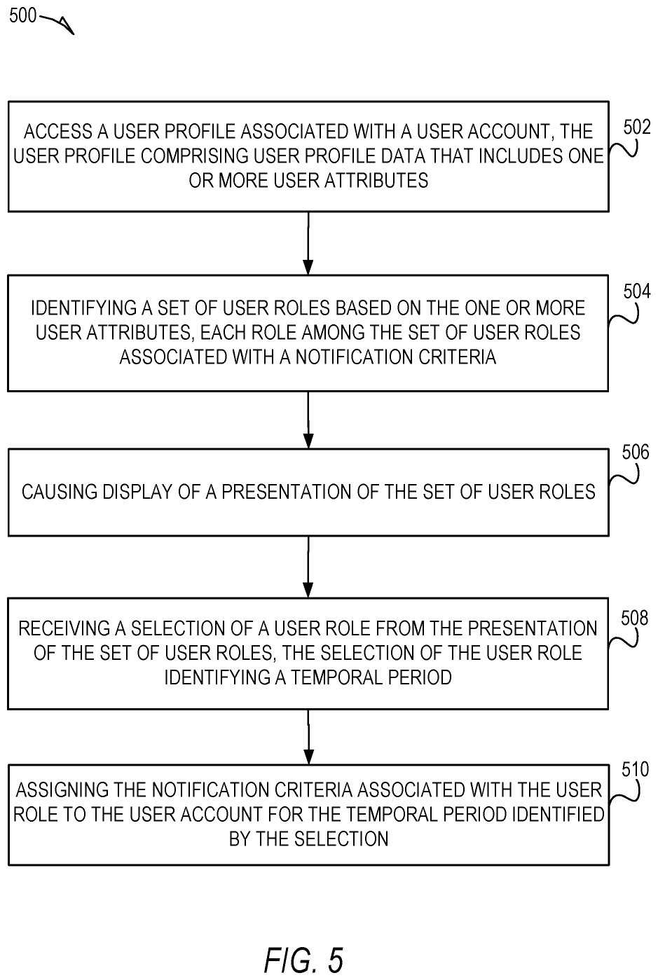

FIG. 5 is a flowchart illustrating a method 500 for assigning a set of notification criteria to a user account, according to certain example embodiments. Operations of the method 500 may be performed by the modules described above with respect to FIG. 2. As shown in FIG. 5, the method 500 includes one or more operations 502, 504, 506, 508, and 510.

At operation 502, the user profile module 208 accesses a user profile associated with a user account, wherein the user profile comprises user profile data that includes one or more attributes. According to certain example embodiments, the user profile module 208 may access the user profile associated with the user account responsive to receiving a request to access the user profile, such as through a login request by a user.

At operation 504, the context module 204 identifies a set of user roles based on the user profile data from the user profile, wherein each role among the set of user roles is associated with a corresponding notification criteria. The notification criteria define rules and conditions for presenting notifications at a client device 110 associated with the user account, as well as attributes of an alert which may or may not be presented. For example, the notification criteria may indicate: urgency of certain trigger events for a given user role; how message content from a notification is to be presented to a user at a client device; when a notification is to be presented to a user at a client device; as well as how frequently a notification is to be delivered to a user at a client device, or whether or not a notification must be elevated in urgency level if a read receipt is not received from the client device.

In some embodiments, the notification criteria may indicate whether or not a notification must be re-sent via a different communication pathway. For example, according to certain embodiments discussed herein, the system may include an auxiliary device 130 that is communicatively coupled with the client device 110 via one or more communication pathways 108, while the client device 110 may be coupled with application servers 140 associated with the contextual notification system 150 via a network 104, wherein the network 104 may further comprise a Wi-Fi network, as well as a cellular network that includes 4G and 5G. Accordingly, a notification delivered via the network 104 may fail to reach the client device 110, and as a result, a read receipt may not be received at the application servers 140. In such a scenario, a threshold time may be defined to cause the contextual notification system 150 to re-send a notification to a particular client device 110 from among a plurality of recipient devices of the notification, wherein the contextual notification system 150 may re-send the same notification to the auxiliary device 130 via the communication pathway 118, wherein the auxiliary device 130 may forward the notification to the client device 110 via the communication pathway 108.

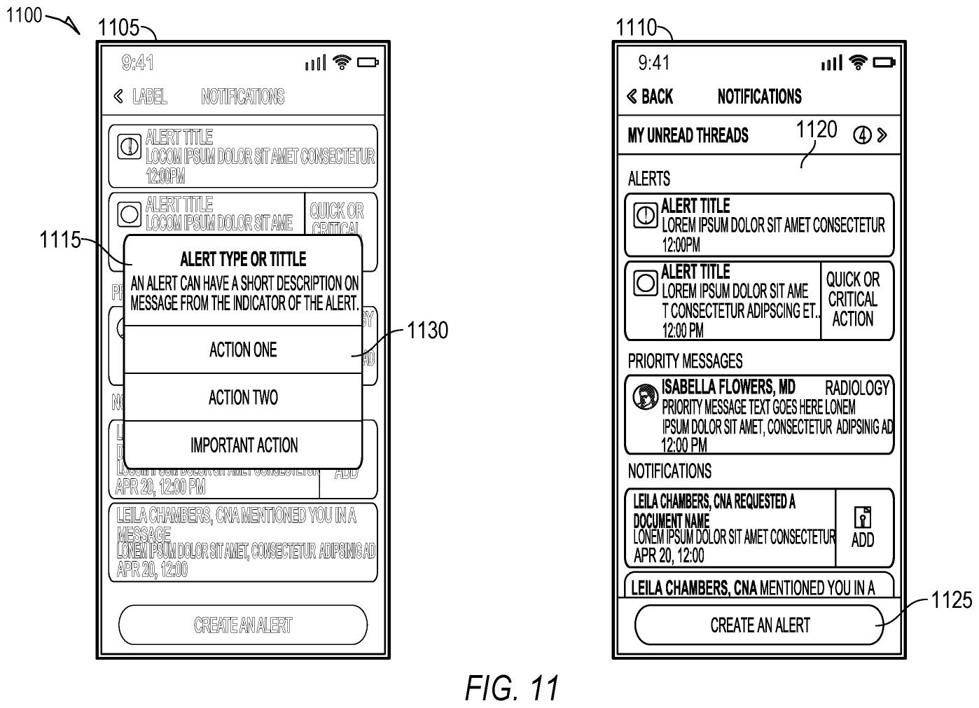

Conditions associated with each user role may be further based on geo-location criteria, temporal criteria, event attributes, as well as a user status which may be set by the user. Attributes of the alert may include graphical properties of the notification (i.e., what the notification looks like) as well as auditory properties of the notification. Further details of alert attributes are depicted in the interface diagram 1100 depicted in FIG. 11.

In some embodiments, a user may personalize notification criteria associated with each user role based on a set of user inputs selecting or defining the notification criteria through a series of GUI presented at the client device 110. For example, responsive to receiving a login request from the user, the presentation module 206 may generate and cause display of a GUI to receive inputs defining notification criteria associated with each user role. In further embodiments, the definition of the notification criteria associated with each user role may be performed by a user with administrative credentials within the system

In some embodiments, the context module 206 may identify the set of user roles based on the one or more user attributes associated with the user profile. For example, the user attributes may include: scheduling data indicating hours when a user is on-call, or on-shift; a user's rank within an organization; as well as a user-history that includes past user roles of the user.

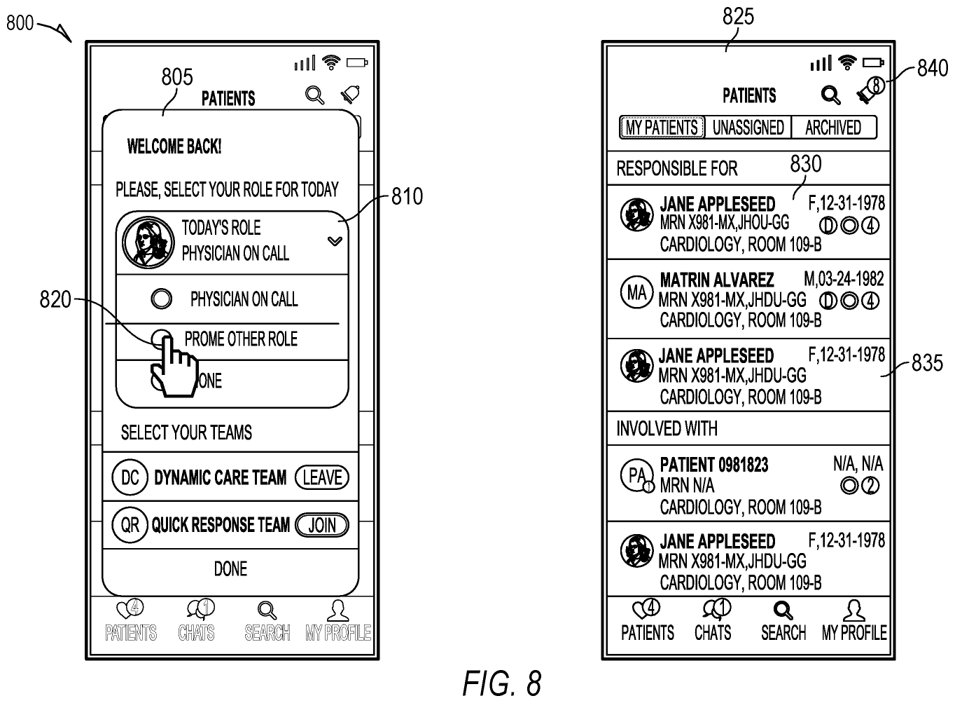

At operation 506, the presentation module 206 generates and causes display of a presentation of the set of user roles within a GUI at a client device 110. For example, as depicted in the interface flow diagram 800 of FIG. 8, responsive to receiving a login request from a user, the presentation module 206 may generate and cause display of the GUI 805 at the client device 110, wherein the GUI 805 includes a presentation of the set of user roles 810. As seen in FIG. 8, in some embodiments the presentation of the set of user roles 810 may be presented as a radio selection configured to receive a user input that selects one or more user roles.

Accordingly, at operation 508, the context module 204 receives a selection of one or more user roles from among the presentation of the set of user roles 810. In some embodiments, the selection may further define a temporal period which may be based on an identification of a start and end time and date, or in some embodiments may be based on a start and end condition, wherein the condition may include one or more trigger conditions. For example, the trigger conditions may include geo-location conditions, or event-based trigger conditions.

At operation 510, the user profile module 208 assigns the notification criteria associated with the selected user roles to the user account for the temporal period defined by the selection. In some embodiments, responsive to assigning the notification criteria associated with the selected user roles to the user account, the communication module 202 may access the databases 126 to retrieve a plurality of data objects that include messages and media objects associated with the selected user roles, and populates a messaging interface associated with the user with the plurality of data objects. For example, as seen in the GUI 825 depicted in FIG. 8, the plurality of data objects may include the message threads 830, wherein each message thread (i.e., message thread 835) among the plurality of message threads 830 may comprise a set of messages that include corresponding media such as images and message content.

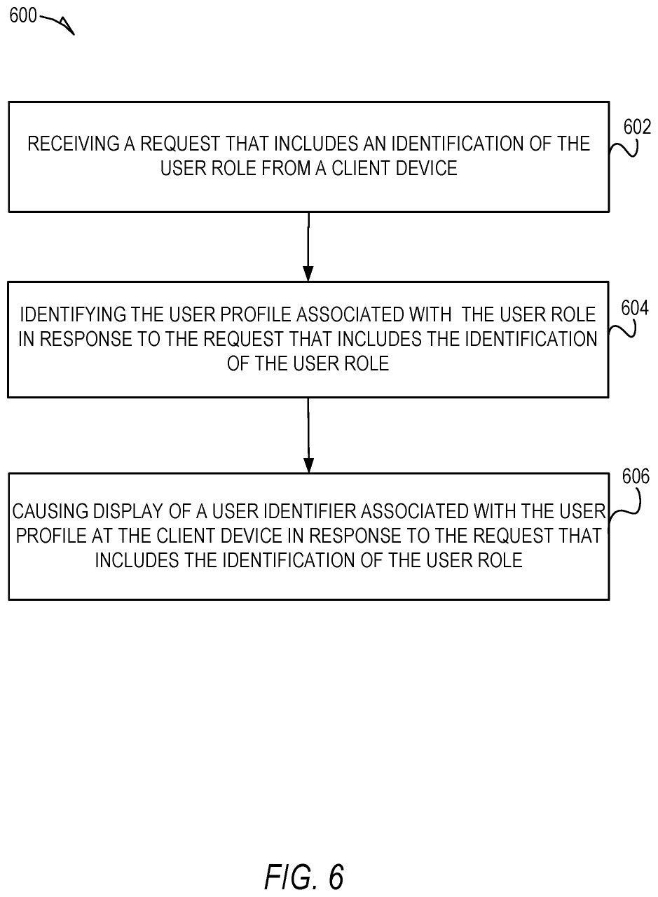

FIG. 6 is a flowchart illustrating a method 600 for presenting a contextual search result, according to certain example embodiments. Operations of the method 600 may be performed by the modules described above with respect to FIG. 2. As shown in FIG. 6, the method 600 includes one or more operations 602, 604, and 606.

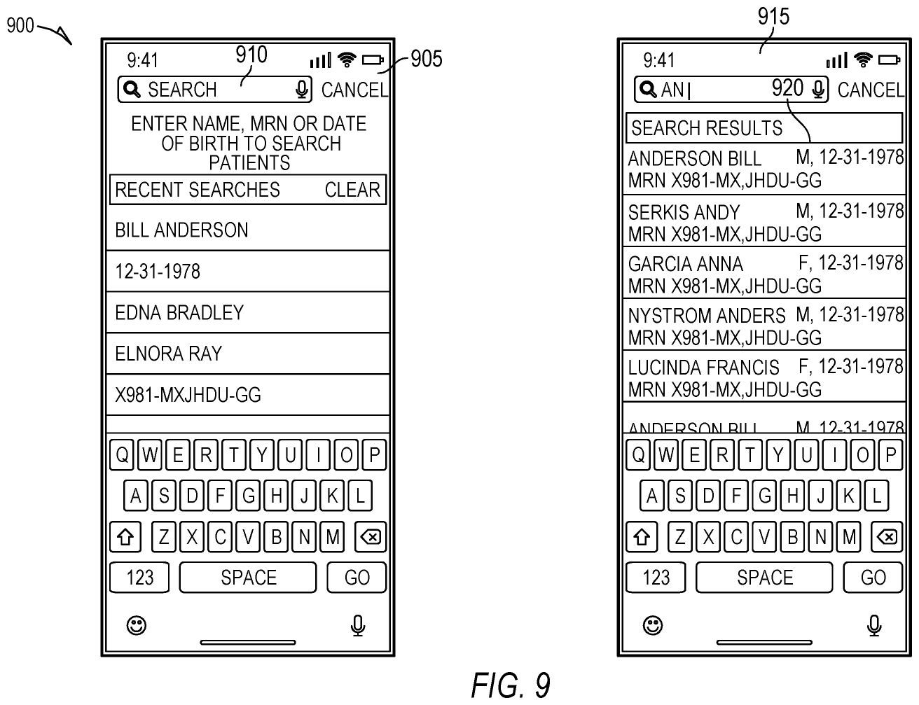

At operation 602, the context module 204 receives a request that includes an identification of a user attribute, such as a user role, from a client device (i.e., the client device 110). For example, as seen in the interface flow diagram 900 depicted in FIG. 9, the presentation module 206 may generate and cause display of a search interface 905 at the client device, wherein the search interface 905 may include a field 910 to receive a user input, such as a text input. The text input may for example include an identification of one or more of: a user identifier; a user role; a shift; a patient identifier; a specialty identifier (i.e., anesthesiology, plastic surgery, dermatology, neurosurgery, nurse).

The text input may comprise a string of characters received based on user inputs provided by a user of the client device 110. At operation 604, responsive to receiving at least a portion of the text input, the context module 204 identifies one or more user profiles from among a plurality of user profiles based on the user attribute identified in the request, and one or more contextual factors. For example, the contextual factors may include a current location of the client device 110, as well as temporal data, such as a time of day. As an illustrative example, the user 106 of the client device 110 may submit a request for “On-Call.” Responsive to receiving the request, the user profile module 208 may access a repository (i.e., the database 126) to identify which doctor (i.e., user) is the on-call doctor at the time in which the user 106 submitted the request.

In certain embodiments, location data may also be taken into consideration. For example, some hospitals may be a part of a larger group of hospitals which comprise multiple locations that may be at distinct geographical locations. In such embodiments, determining which “on-call” doctor from among a plurality of “on-call” doctors may be necessary. As a result, in such embodiments, the user profile module 208 may access location data at the client device 110 to determine a location of the client device 110 responsive to receiving the request as in operation 602. The user profile module 208 may then identify one or more user profiles based on the text input and the location of the client device 110.

At operation 606, responsive to the user profile module 208 identifying the one or more user profiles, the presentation module 208 causes display of a presentation of one or more user identifiers associated with the one or more user profiles at the client device 110. For example, as seen in the GUI 915, the presentation module 208 may display the presentation of the one or more user identifiers 920 within the GUI 915, wherein the presentation of the one or more user identifiers 920 may include a display of the corresponding user roles. A user may provide an input selecting one or more of the user identifiers 920, and in responsive, the presentation module 208 may cause display of additional information pertaining the selected identifier. The additional information may include a name, a title, a position, a department, a specialty, a sub-specialty, contact information (i.e., phone number, email address), a schedule indicating shift times, whether they are available or busy or available (based on a current time and the schedule), how long they are busy or available (based on a current time and the schedule), as well as user-defined information. For example, the presentation module 208 may access the database 126 to retrieve past messages associated with the selected identifier.

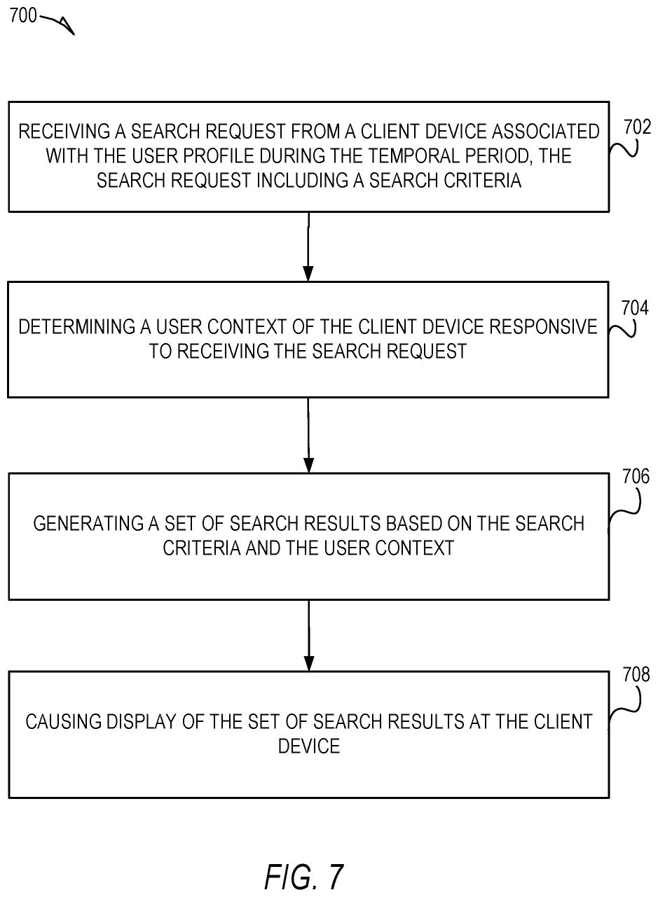

FIG. 7 is a flowchart illustrating a method 700 for presenting a contextual search result, according to certain example embodiments. Operations of the method 700 may be performed by the modules described above with respect to FIG. 2. As shown in FIG. 7, the method 700 includes one or more operations 702, 704, 706, and 708. According to certain embodiments, the method 700 may be performed as a subroutine of the method 500, subsequent to operation 510 wherein notification criteria is associated with a user account for a temporal period.

At operation 702, the context module 202 receives a search request that comprises a set of search criteria from a client device 110 associated with a user 106, during a temporal period in which a user profile of the user 106 is associated with a user role. According to certain embodiments, the user role may be associated with a plurality of patient accounts within a repository (i.e., the database 126). For example, in a clinical/hospital scenario, multiple doctors and staff may be responsible for a single patient. In such a scenario, the doctors and staff responsible for the single patient may change on a temporal basis, based on a schedule associated with the doctors and staff. In such embodiments, a user role may include an indication of a user being “on-call,” wherein when the user is “on-call,” they may be responsible for a number of patients based on their area of specialty.

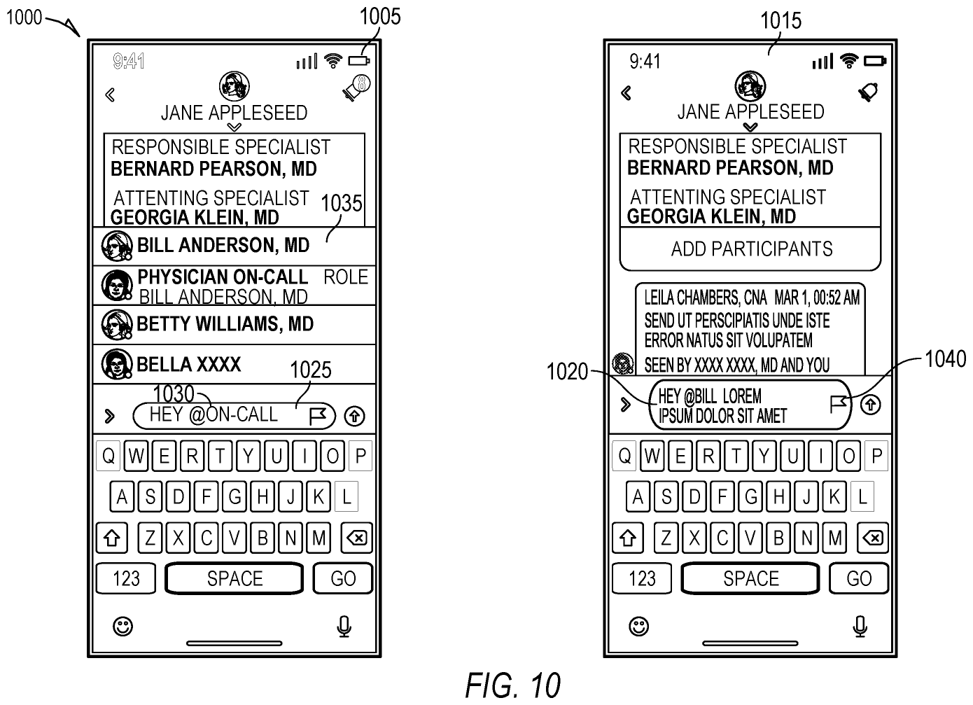

For example, as seen in the interface flow diagram 1000 depicted in FIG. 10, the presentation module 206 may cause display of the search interface 1005 at the client device 110, wherein the search interface 1005 may include a display of recent searches 1010 at a position within the search interface 1005.

At operation 704, the context module 204 determines a user context of the client device 110 in response to the search request. For example, the user context may include one or more of a time of day, a location, user attributes of the user 106, as well as user behavior and activities performed by the user 106 that may include past search requests, a schedule of the user 106 indicating shift times of the user 106, or upcoming appointments of the user 106. For example, the schedule may indicate that the user 106 is set to see a patient for a particular procedure in the near future, wherein the patient may be identified by a corresponding patient identifier, and the patient identifier is associated with a profile that contains attributes and information of that patient.

In some embodiments, determination of the user context may be based on a schedule, wherein the schedule comprises a list of events associated with the user 106 of the client device 110, wherein each event among the list of events comprises event attributes. Event attributes may include: temporal information (i.e., when is the event); location information (i.e., where is the event); event type (i.e., surgery, check-up, exam, etc.); as well as an identification of one or more parties or individuals associated with the event (i.e., user identifier, patient identifier). Responsive to receiving the search request as in operation 702, the context module 204 may access the schedule to identify one or more upcoming events, wherein the upcoming events have corresponding event attributes. The context module 204 may therefore determine the user context of the user 106 based on the event attributes of the upcoming events.

At operation 706, the context module 202 generates a set of search results based on the search criteria and the user context, which may include the user role associated with the user profile during the given temporal period, and causes display of a presentation of the set of search results at the client device 110 at operation 708. According to certain example embodiments, to generate the set of search results, the context module 202 may generate the set of search results based on a plurality of patient accounts associated with the user account during the temporal period and based on the role. Accordingly, the context module 202 may not necessarily need to query the entire database 126 to identify the set of search results, but rather may simply query a portion of the database 126 that comprises the patient accounts relevant to the user 106 during the temporal period based on the user role for that temporal period.

In some embodiments, generating the set of search results may include assigning a relevance score to each data object among a collection of data objects within a repository such as the database 126, or among the portion of the collection of data objects which are relevant to the user 106 during the temporal period. The relevance score may be based on the user context determined at operation 704. As an illustrative example, the user context of the user 106 may indicate a location of the user 106, a time of day, as well as an upcoming appointment of the user 106, wherein the upcoming appointment is to perform a procedure upon a patient identified by a patient identifier. The context module 204 may therefore access the database 126 and assign a relevance score to each data object among a collection of data objects within the database 126 by assigning a higher score to data objects corresponding with the user context.

The context module 204 may then rank the data objects among the collection of data objects in order to identify a subset of the collection of data objects to be presented to the user 106 as a set of search results, as in operation 708. Accordingly, a sort order of the set of search results may be based on the corresponding relevance scores.

As seen in the search interface 1015 depicted in FIG. 10, the set of search results 1020 may comprise a list of patient identifiers associated with the patient accounts.

FIG. 8 is an interface flow-diagram 800 depicting interfaces generated and displayed by the contextual notification system 150, according to certain example embodiments, and as described in the method 500.

As seen in FIG. 8, the interfaces may include a GUI 805 that includes a presentation of the set of user roles 810. In some embodiments the presentation of the set of user roles 810 may be presented as a radio selection configured to receive a user input (i.e., the user input 820 that selects one or more user roles).

In some embodiments, as depicted in FIG. 8, the user roles 810 may include user groups which the user may join. For example, each user group may comprise a set of user identifiers, wherein a notification distributed to the user group causes the notification to be presented at a plurality of client device 110 associated with the users of the user group, wherein the notification may be presented to each of the users of the user group based on corresponding notification criteria associated with each user among the plurality of users.

In some embodiments, responsive to receiving an input 820 that selects one or more user roles (or user groups), the contextual notification system 150 may cause display of the GUI 825, wherein the GUI 825 comprises a display of message threads 830 associated with the selected user roles and user groups. For example, the contextual notification system 150 may access the databases 126 to retrieve content associated with the message threads 830 responsive to receiving the input 820 that selects the corresponding user role or user group. Accordingly, as seen in FIG. 8, each message thread (i.e., message thread 835) among the plurality of message threads 830 may comprise a set of messages that include corresponding media such as images and message content. Notification distributed via the contextual notification system 150 may in some embodiments be presented to the user 106 of the client device 110 via the GUI 825. In some embodiments, the contextual notification system 150 may present an indication of a notification as the notification icon 840.

FIG. 9 is an interface flow-diagram 900 depicting interfaces generated and displayed by the contextual notification system 150, according to certain example embodiments, and as described in the methods 600, and 700.

As seen in the GUI 905, the contextual notification system 150 may generate and cause display of the search interface 905 at the client device, wherein the search interface 905 may include a field 910 to receive a user input, such as a text input. The text input may for example include an identification of one or more of: a user identifier; a user role; a shift; a patient identifier; a specialty identifier (i.e., anesthesiology, plastic surgery, dermatology, neurosurgery, nurse).

As seen in the GUI 915, the set of search results that may include the one or more user identifiers 920. According to certain embodiments, the presentation of the one or more user identifiers 920 may include a display of the corresponding user roles. A user may provide an input selecting one or more of the user identifiers 920, and in responsive, the contextual notification system 150 may cause display of additional information pertaining the selected identifier.

FIG. 10 is an interface flow-diagram 1000 depicting interfaces generated and displayed by the contextual notification system 150, according to certain example embodiments, and as discussed in the method 600 depicted in FIG. 6.

As seen in the GUI 1005, a user 106 of the contextual notification system 150 may generate message content to be included in a notification distributed by the contextual notification system 150 by providing an input into the user input field 1025. In some embodiments, the user 106 may identify one or more recipients of a notification by providing an input that identifies a user role or user attribute associated with a particular user, as described in the method 600 depicted in FIG. 6. For example, a user 106 may provide the input 1030 that comprises an identification of a user attribute. Responsive to receiving the input 1030 that identifies the user attribute, the contextual notification system 150 generates and causes display of a presentation of a plurality of user identifiers 1035 that are associated with the user attribute from the input 1030. As seen in the flow-diagram 1000, the input 1030 may include the phrase “on-call,” indicating that the user 106 of the client device 110 is looking for whoever is on-call for a given patient.

In some embodiments, generation and display of the presentation of the plurality of user identifiers 1035 may be based on the input 1030, as well as attributes of a current context of the user 106 at the client device 110. The current context of the user 106 may be based on time of day, location, current user activity, recent searches (what did the user 106 recently search for), as well recent messages (i.e., who did they recently communication with). For example, as seen in the GUI 1005, the user 106 may have been discussing or display information related to a particular patient (i.e., Jane Appleseed) at the client device 110 when the began to search for the doctor on-call. The contextual search interface 150 may therefore receive the input 1030, determine the current context of the user 106, and then identify the plurality of user identifiers 1035 based on the input 1030 and the current context.

As seen in the GUI 1015, the contextual notification system 150 may generate the message 1020 based on the input 1030 received in the GUI 1005. In some embodiments, the user may prioritize a message by providing an input that selects a graphical element presented within the GUI 1015, such as the prioritization icon 1040. In some embodiments, the contextual notification system 150 may distribute the notification based on whether or not the graphical element 1040 has been selected. For example, in some embodiments, selection of the prioritization icon 1040 may cause the notification to be delivered via a particular communication pathway, such as the communication pathway 118 (i.e., send as page), and may also assign the notification certain graphical properties, including how the notification is presented at a client device 110 (i.e., as a pop-up such as the notification 1115 of FIG. 11, as a blinking light, as a notification icon, such as the notification icon 840 of FIG. 8).

As an illustrative example, a user 106 may provide an input that selects the prioritization icon 1040. Responsive to receiving the selection of the prioritization icon 1040, the contextual notification system 150 generates and distributes a prioritized message to a plurality of recipients.

Generation of the prioritized message comprise operations that include formatting content of the message based on a communication pathway 118, wherein the communication pathway 118 may include a pager network that has a corresponding protocol, and wherein the protocol has an associated maximum transmission unit (MTU). Responsive to receiving the input selecting the prioritization icon 1040, the contextual notification system 150 access content of the message 1020 in order to determine how many data packets may need to be distributed in order to send all of the message to the recipients, based on the MTU that corresponds with the communication pathway 118. The contextual notification system 150 then distributes the message to the plurality of recipients via the communication pathway 118.

FIG. 11 is an interface flow-diagram 1100 depicting interfaces generated and displayed by the contextual notification system 150, according to certain example embodiments.

As seen in the GUI 1105, a notification 1115 may be presented at a client device 110 based on the notification criteria associated with a user role of the user 106. The notification 1115 may comprise a display of a message content, as well as an identification of a sender of the notification.

In some embodiments, the notification 1115 may also include a display of a set of graphical icons 1130, wherein the user 106 may provide an input to select one or more of the set of graphical icons 1130. In certain embodiments, each graphical icon from among the set of graphical icons 1130 may correspond with a predefined response message, which may be configured by the user 106. The predefined response message may in some embodiments correspond with one or more notification attributes, such that receipt of a notification that comprises a set of notification attributes results in a display of a set of predefined response messages based on the notification attributes from the notification.

As seen in the GUI 1110, the contextual notification system 150 may display a presentation of notifications 1120 that the user 106 has received, wherein a sort order of the presentation of notifications 1120 may be determined based on notification criteria associated with the user 106, as well as attributes of the notifications themselves. For example, notifications marked high priority may automatically be presented at a higher priority location within the presentation of notifications 1120.

In some embodiments, the user 106 may provide an input selecting the alert element 1125 in order to create an alert. According to certain embodiments, responsive to receiving an input selecting the alert element 1125, the presentation module 206 generates and causes display of a set of alert options, wherein the alert options include a set of identifiers that correspond with one or more distribution lists that comprise a list of recipients. For example, the distribution lists may include different teams of users based on specialty, time of day, department, or a particular patient.

The user may provide a selection of a distribution list of from among the set of alert options, and in response, the presentation module 206 may present an interface to provide inputs that define message content to be distributed in the alert. Based on the message content, the contextual notification system 150 may then distribute and cause display of the alert to the list of recipients associated with the selected distribution list. Recipients of the alert may then be presented with a notification, such as the notification 1115, wherein the notification 1115 may include a display of the set of graphical icons 1130, wherein the user 106 that generated the alert may define contents of the set of graphical icons 1130.

In some embodiments, the contextual notification system 150 may present a notification such as the notification 1115 and require recipients of the notification 1115 to provide an input selecting one of the options from among the set of graphical icons 1130, before clearing the notification 1115 from display.

Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example Machine Architecture and Machine-Readable Medium

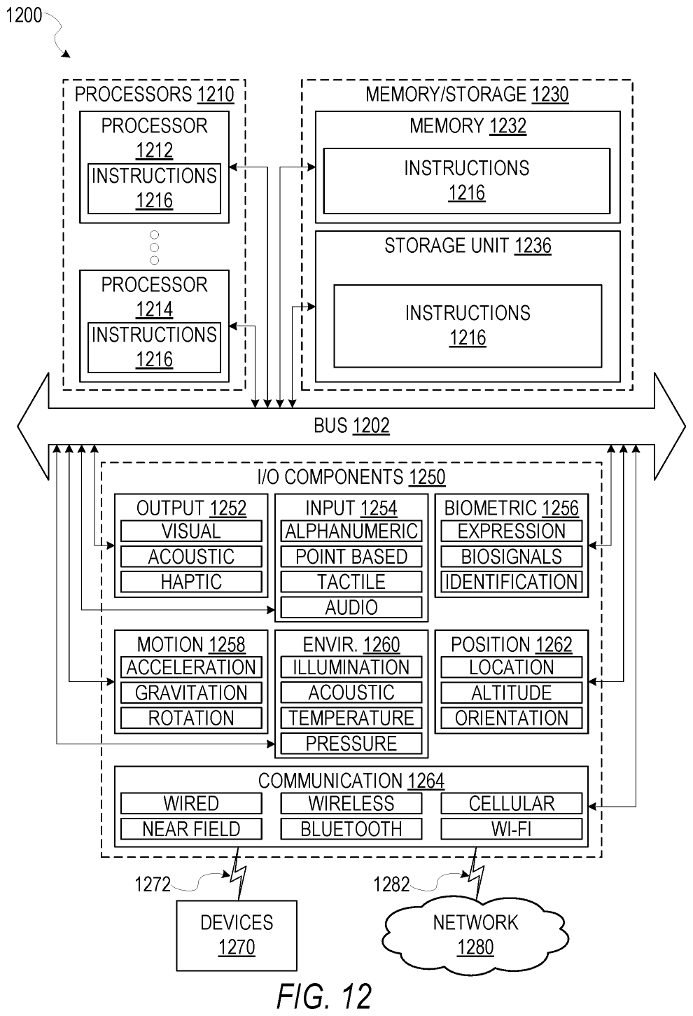

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. Additionally, or alternatively, the instructions may implement the modules of FIG. 2. The instructions transform the general, non-programmed machine into a specially configured machine programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment.

The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 includes processors 1210, memory 1230, and I/O components 1250, which may be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1212 and processor 1214 that may execute instructions 1216. The term “processor” is intended to include multi-core processor that may comprise two or more independent processors (sometimes referred to as “cores”) that may execute instructions contemporaneously. Although FIG. 12 shows multiple processors, the machine 1200 may include a single processor with a single core, a single processor with multiple cores (e.g., a multi-core process), multiple processors with a single core, multiple processors with multiples cores, or any combination thereof.

The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of processors 1210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes transitory signals per se.

The I/O components 1250 may include a wide variety of components to receive input, provide output, produce output, transmit information, exchange information, capture measurements, and so on. The specific/O components 1250 that are included in a particular machine will depend on the type of machine. For example, portable machines such as mobile phones will likely include a touch input device or other such input mechanisms, while a headless server machine will likely not include such a touch input device. It will be appreciated that the UO components 1250 may include many other components that are not shown in FIG. 12. The I/O components 1250 are grouped according to functionality merely for simplifying the following discussion and the grouping is in no way limiting. In various example embodiments, the I/O components 1250 may include output components 1252 and input components 1254. The output components 1252 may include visual components (e.g., a display such as a plasma display panel (PDP), a light emitting diode (LED) display, organic light-emitting diode (OLED), a liquid crystal display (LCD), a projector, or a cathode ray tube (CRT)), electronic paper (e-paper), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environmental components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1262 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via coupling 1282 and coupling 1272 respectively. For example, the communication components 1264 may include a network interface component or other suitable device to interface with the network 1280. In further examples, communication components 1264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a Universal Serial Bus (USB)).

Moreover, the communication components 1264 may detect identifiers or include components operable to detect identifiers. For example, the communication components 1264 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as, location via Internet Protocol (IP) geo-location, location via Wi-Fi® signal triangulation, location via detecting a NFC beacon signal that may indicate a particular location, and so forth.

Transmission Medium

In various example embodiments, one or more portions of the network 1280 may be an ad hoc network, an intranet, an extranet, a pager network, a Simple Network Paging Protocol (SNPP), a Telelocator Alphanumeric Protocol (TAP), FLEX, ReFLEX, Post Office Code Standardisation Advisory Group (POCSAG), GOLAY, Enhanced Radio Messaging System (ERMS), and NTT, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network and the coupling 1282 may be a Code Division Multiple Access (CDMA) connection, a Global System for Mobile communications (GSM) connection, or other type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 may be transmitted or received over the network 1280 using a transmission medium via a network interface device (e.g., a network interface component included in the communication components 1264) and utilizing any one of a number of well-known transfer protocols (e.g., hypertext transfer protocol (HTTP)). Similarly, the instructions 1216 may be transmitted or received using a transmission medium via the coupling 1272 (e.g., a peer-to-peer coupling) to devices 1270. The term “transmission medium” shall be taken to include any intangible medium that is capable of storing, encoding, or carrying instructions 1216 for execution by the machine 1200, and includes digital or analog communications signals or other intangible medium to facilitate communication of such software.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A method comprising:
accessing a user profile associated with a user account, the user profile comprising user profile data that includes one or more user attributes;
identifying a set of user roles based on the one or more user attributes, each role among the set of user roles associated with at least a notification criteria;
causing display of a presentation of the set of user roles;
receiving a selection of a user role from among the presentation of the set of user roles, the user role corresponding with a temporal period within a schedule; and
assigning the notification criteria associated with the user role to the user account for the temporal period that correspond with the user role within the schedule.

2. The method of claim 1, wherein the duration includes one or more of:
a temporal period that comprises a start time and an end time;
an event based period that comprises at least a termination event; and
a location based period that comprises at least a termination location.

3. The method of claim 1, wherein the presentation of the set of roles includes a radio selection.

4. The method of claim 1, wherein the method further comprises:
receiving a request that includes an identification of the user role from a client device;
identifying the user profile associated with the user role in response to the request that includes the identification of the user role; and
causing display of a user identifier associated with the user profile at the client device in response to the receiving the request that includes the identification of the user role.

5. The method of claim 1, wherein the method further comprises:
receiving a request that includes an identification of the duration;
identifying the user profile associated with the user role during the duration in response to the request that includes the identification of the user role; and
causing display of a user identifier associated with the user profile at the client device in response to the receiving the request that includes the identification of the duration.

6. The method of claim 1, wherein the method further comprises:
receiving a search request from a client device associated with the user profile during the duration, the search request including a search criteria;
generating a set of search results based on the search criteria and the user role associated with the user profile during the duration; and
causing display of the set of search results at the client device.

7. The method of claim 6, wherein the set of search results comprise a first portion and a second portion, and the generating the set of search results includes:
generating the first portion of the set of search results based on the user role and the search criteria;
generating the second portion of the set of search results based on the search criteria; and
wherein the causing display of the set of search results at the client device includes:
presenting the first portion of the set of search results at a first position within a graphical user interface (GUI) at the client device; and
presenting the second portion of the set of search results at a second position within the GUI at the client device.

8. A system comprising:
one or more processors; and
a memory storing instructions that, when executed by at least one processor among the one or more processors, cause the system to perform operations comprising:
accessing a user profile associated with a user account, the user profile comprising user profile data that includes one or more user attributes;
identifying a set of user roles based on the one or more user attributes, each role among the set of user roles associated with at least a notification criteria;
causing display of a presentation of the set of user roles;
receiving a selection of a user role from among the presentation of the set of user roles, the user role corresponding with a temporal period within a schedule; and
assigning the notification criteria associated with the user role to the user account for the temporal period that corresponds with the user role within the schedule.

9. The system of claim 8, wherein the duration includes one or more of:
a temporal period that comprises a start time and an end time;
an event based period that comprises at least a termination event; and
a location based period that comprises at least a termination location.

10. The system of claim 8, wherein the presentation of the set of roles includes a radio selection.

11. The system of claim 8, wherein the instructions cause the system to perform operations further comprising:
receiving a request that includes an identification of the user role from a client device;
identifying the user profile associated with the user role in response to the request that includes the identification of the user role; and
causing display of a user identifier associated with the user profile at the client device in response to the receiving the request that includes the identification of the user role.

12. The system of claim 8, wherein the instructions cause the system to perform operations further comprising:
receiving a request that includes an identification of the duration;
identifying the user profile associated with the user role during the duration in response to the request that includes the identification of the user role; and
causing display of a user identifier associated with the user profile at the client device in response to the receiving the request that includes the identification of the duration.

13. The system of claim 8, wherein the instructions cause the system to perform operations further comprising:
receiving a search request from a client device associated with the user profile during the duration, the search request including a search criteria;
generating a set of search results based on the search criteria and the user role associated with the user profile during the duration; and
causing display of the set of search results at the client device.

14. The system of claim 13, wherein the set of search results comprise a first portion and a second portion, and the generating the set of search results includes:
generating the first portion of the set of search results based on the user role and the search criteria;
generating the second portion of the set of search results based on the search criteria; and
wherein the causing display of the set of search results at the client device includes:
presenting the first portion of the set of search results at a first position within a graphical user interface (GUI) at the client device; and
presenting the second portion of the set of search results at a second position within the GUI at the client device.

15. A non-transitory machine-readable storage device storing instructions that, when executed by one or more processors, cause the one or more processors to perform operations comprising:
accessing a user profile associated with a user account, the user profile comprising user profile data that includes one or more user attributes;
identifying a set of user roles based on the one or more user attributes, each role among the set of user roles associated with at least a notification criteria;
causing display of a presentation of the set of user roles;
receiving a selection of a user role from among the presentation of the set of user roles, the user role corresponding with a temporal period within a schedule; and
assigning the notification criteria associated with the user role to the user account for the temporal period that corresponds with the user role within the schedule.

16. The non-transitory machine-readable storage device of claim 15, wherein the duration includes one or more of:
a temporal period that comprises a start time and an end time;
an event based period that comprises at least a termination event; and
a location based period that comprises at least a termination location.

17. The non-transitory machine-readable storage device of claim 15, wherein the presentation of the set of roles includes a radio selection.

18. The non-transitory machine-readable storage device of claim 15, wherein the instructions cause the one or more processors to perform operations further comprising:
receiving a request that includes an identification of the user role from a client device;
identifying the user profile associated with the user role in response to the request that includes the identification of the user role; and
causing display of a user identifier associated with the user profile at the client device in response to the receiving the request that includes the identification of the user role.

19. The non-transitory machine-readable storage device of claim 15, wherein the instructions cause the one or more processors to perform operations further comprising:
receiving a request that includes an identification of the duration;
identifying the user profile associated with the user role during the duration in response to the request that includes the identification of the user role; and
causing display of a user identifier associated with the user profile at the client device in response to the receiving the request that includes the identification of the duration.

20. The non-transitory machine-readable storage device of claim 15, wherein the instructions cause the one or more processors to perform operations further comprising:
receiving a search request from a client device associated with the user profile during the duration, the search request including a search criteria;
generating a set of search results based on the search criteria and the user role associated with the user profile during the duration; and
causing display of the set of search results at the client device.
